(19) United States
(12) Patent Application Publication
(10) Pub. No.: US 2014/0362305 A1
(43) Pub. Date: Dec. 11, 2014

(54) TOUCH PANEL ASSEMBLY STRUCTURE

(71) Applicant: ILI TECHNOLOGY CORP., Hsinchu County (TW)

(72) Inventors: YUNG-HSIN YAO, Hsinchu City (TW); JIM HSU, Hsinchu County (TW)

(73) Assignee: ILI TECHNOLOGY CORP., Hsinchu County (TW)

(21) Appl. No.: 14/083,532

(22) Filed: Nov. 19, 2013

(30) Foreign Application Priority Data
Jun. 10, 2013 (TW) 102120500

(51) Int. Cl. G06F 3/044

(52) U.S. Cl. CPC G06F 3/044
USPC 349/12

(57) ABSTRACT

A touch panel assembly structure includes a touch sensor substrate, a cover lens, a sealing frame, and a plurality of transparent elastic elements. The cover lens is facing the touch sensor substrate. The surface of the touch sensor substrate having a sensing region, and the sealing frame is disposed on the surface of the touch sensor substrate and surrounding the sensing region. The sealing frame includes a sealing colloid and a plurality of spacers mixed into the sealing colloid. The cover lens is attached to the touch sensor substrate by the sealing frame such that a gap is formed between the touch sensor substrate and the cover lens. The transparent elastic elements are disposed in the gap and arranged within the sensing region.

### BACKGROUND

1. Field of the Invention

The instant disclosure relates to structural arrangement of electronic digital data processing accessories, and pertains particularly to a touch panel assembly structure.

2. Description of Related Art

Touch panels are widely implemented in electronic devices as the user interface technology advances, for example, mobile phones, navigation systems, tablets, personal digital assistant (PDA), industrial control panel and the like. According to different transmitting media, touch panels are generally categorized as resistive, capacitive, optical and sonic touch panels. For example, a display device with a touch panel allows users to use the fingers or the stylus to directly tap or press the device screen to operate, thereby providing a more convenient and user-friendly mode of operation.

### SUMMARY OF THE INVENTION

The embodiment of the instant disclosure provides a touch panel assembly structure. The touch panel assembly structure utilizes spacers mixed into a sealing colloid to keep the sealing frame to have a thickness in a predetermined value. In addition, the touch panel assembly structure utilizes transparent elastic elements to hold up the deformed cover lens against the pressing force down to the touch sensor substrate and keep the cover lens with respect to the sensing region A from being in direct contact with or stuck onto the touch sensor substrate.

The touch panel assembly structure in accordance with the instant disclosure comprises a touch sensor substrate, a cover lens, a sealing frame, and a plurality of transparent elastic elements. The cover lens is facing the touch sensor substrate. The surface of the touch sensor substrate having a sensing region, and the sealing frame is disposed on the surface of the touch sensor substrate and surrounding the sensing region. The sealing frame comprises a sealing colloid and a plurality of spacers mixed into the sealing colloid. The cover lens is attached to the touch sensor substrate by the sealing frame such that a gap is formed between the touch sensor substrate and the cover lens. The transparent elastic elements are disposed in the gap and arranged within the sensing region.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The novel features believed characteristic of the invention are set forth in the appended claims. the invention itself, however, as well as a preferred mode of use, further objectives and advantages thereof, will best be understood by reference to the following detailed description of an illustrative embodiments when read in conjunction with the accompanying drawings, wherein:

FIG. 1 illustrates a cross section view of a touch panel assembly structure during one exemplary application in accordance with one embodiment of the instant disclosure.

FIG. 2A illustrates a cross section view of the touch panel assembly structure in accordance with FIG. 1 during one exemplary fabrication step.

FIG. 2B illustrates a cross section view of the touch panel assembly structure in accordance with FIG. 1 during one exemplary fabrication step.

FIG. 2C illustrates a cross section view of the touch panel assembly structure in accordance with FIG. 1 during one exemplary fabrication step.

FIG. 3 illustrates a cross section view of a touch panel assembly structure in accordance with another embodiment of the instant disclosure.

FIG. 4 illustrates a cross section view of a touch panel assembly structure in accordance with another embodiment of the instant disclosure.

### DETAILED DESCRIPTION OF THE PREFERRED EMBODIMENTS

The instant disclosure will be described more specifically with reference to the following embodiments. It is to be noted that the following descriptions of preferred embodiments are provided herein for purpose of illustration and description. It is not intended to be exhaustive or limiting to the precise form disclosed.

### First Embodiment of Touch Panel Assembly Structure

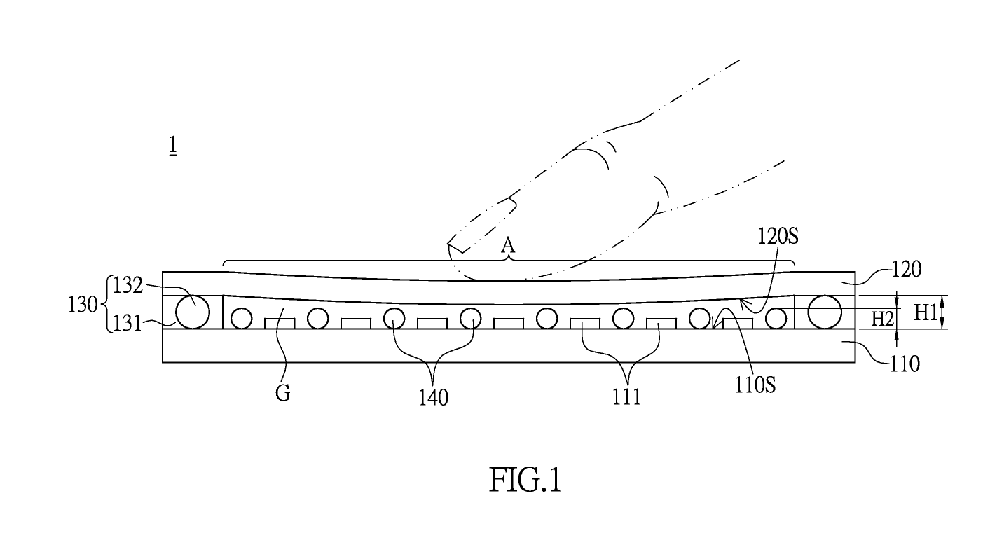

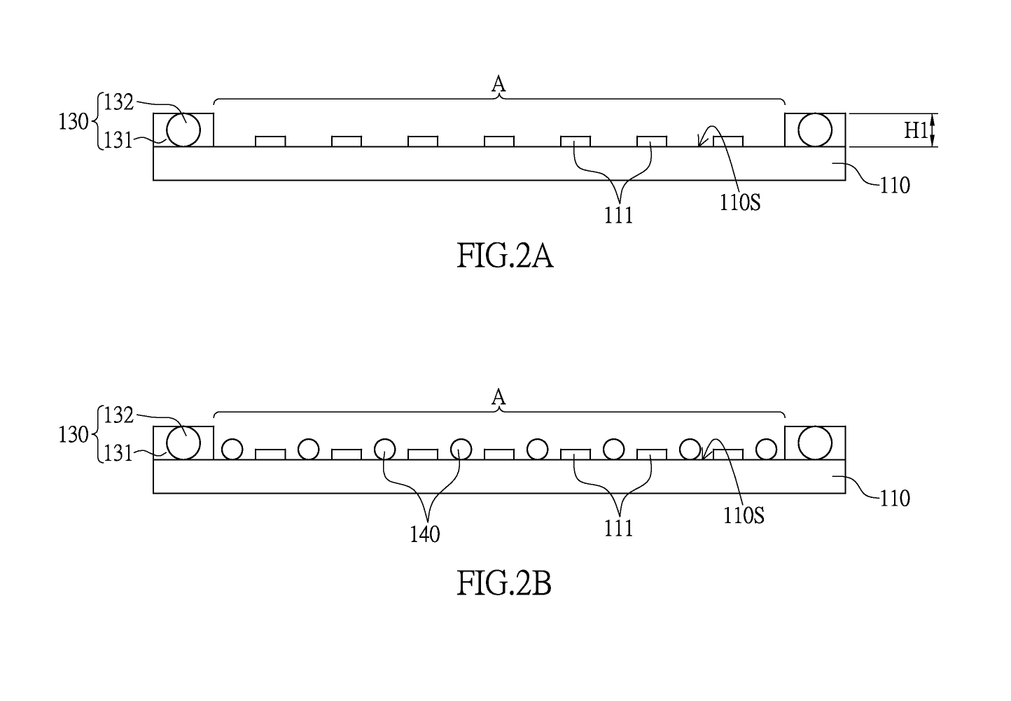

Please refer concurrently to FIG. 1, and FIGS. 2A to 2B. FIG. 1 illustrates a cross section view of a touch panel assembly structure during one exemplary application in accordance with one embodiment of the instant disclosure, and FIGS. 2A to 2b respectively illustrate cross section views of the touch panel assembly structure in accordance with FIG. 1 during one exemplary fabrication step. The touch panel assembly structure 1 includes a touch sensor substrate 110, a cover lens 120, a sealing frame 130, and a plurality of transparent elastic elements 140 (as shown in FIG. 1 or FIG. 2C).

The touch sensor substrate 110 such as a substrate applied to a capacitive type touch panel is for structurally supporting a sensing layer, and may have a single-layered conductive layer or a double-layered conductive layer. For example, the touch sensor substrate 110 can be a substrate applied to an on cell touch panel. In an exemplary embodiment, the touch sensor substrate 110 has a thickness ranging from 0.05 to 0.7 millimeters and is made from plastic material or glass material such as borosilicate glass and soda lime glass. The surface 1105 of the touch sensor substrate 110 has a sensing region A. The touch sensor substrate 110 in the sensing region A is used to sense the user's finger or a capacitance stylus proximate to the surface 1105 of the touch sensor substrate 110, resulting in a change in the capacitance, which is converted to signals in coordinate. As shown in FIG. 1 or FIG. 2C, the sensing region A is located in the central region of the surface 1105.

The cover lens 120 is arranged facing the touch sensor substrate 110 and is used for the user's finger or a capacitance stylus to be in direct contact with. It is worth to note that, the touch sensor substrate 110 and the cover lens 120 can be visually transparent and made from visually transparent material such as glass, acrylic (PMMA), polyethylene terephthalate (PET), polycarbonate (PC) and the like. In one exemplary embodiment, the touch sensor substrate 110 and the cover lens 120 can be flexible or pliable. Other types of the touch sensor substrate 110 or the cover lens 120 may be employed and the instant disclosure is not limited thereto.

The sealing frame 130 is disposed on the surface 110S of the touch sensor substrate 110 and surrounding the sensing region A. The cover lens 120 is attached to the touch sensor substrate 110 by the sealing frame 130 such that a gap G is formed between the touch sensor substrate 110 and the cover lens 120. To put it concretely, the sealing frame 130 is arranged between the touch sensor substrate 110 and the cover lens 120 and adheres both to the peripheral region of the top surface 110S of the touch sensor substrate 110 and to the peripheral region of the bottom surface 120S of the cover lens 120. In the instant disclosure, the sealing frame 130 is surrounding the sensing region A, which is located in the central region of the top surface 110S of the touch sensor substrate 110, and the shape of the sealing frame 130 resembles the shape of a ring. The sealing frame 130 can be formed on the surface 110S of the touch sensor substrate 110 by automatic coating process. The configurations of the sealing frame 130 such as the positioning, the shape, and the dimension of the sealing frame 130 may vary with respect to, for example, the positioning, the shape, or the dimension of the sensing region A and the instant disclosure is not limited thereto.

In addition, the thickness of the sealing frame 130 is for forming the gap G between the touch sensor substrate 110 and the cover lens 120. For example, the thickness of the sealing frame 130 can be greater than the height H2 of the transparent elastic elements 140. Hence, there is sufficient space between the touch sensor substrate 110 and the cover lens 120 with respect to the sensing region A, and the portion of the touch sensor substrate 110 and the cover lens 120 with respect to the sensing region A can be separated and not in direct contact with each other. The distance between the touch sensor substrate 110 and the cover lens 120 is defined by the height H1 of the gap G and substantially equal to the thickness of the sealing frame 130, which for example ranges from 10 to 300 micrometers.

The sealing frame 130 includes a sealing colloid 131 and a plurality of spacers 132 mixed into the sealing colloid 131. The sealing colloid 131 can constitute of heat curing epoxy-based sealing materials, room temperature curing epoxy-based sealing materials, or UV-curable acrylic sealing material. The sealing colloid 131, for example, can be made of an epoxy resin, acrylic ester (acrylate-urethane) resin, or a thermosetting resin. In one exemplary embodiment, the sealing colloid 131 may be a light-heat curable resin, which can be pre-cured by irradiating light and then completely cured by heat treatment, containing acrylic ester (acrylate-urethane) resin and epoxy resin.

When disposed between the touch sensor substrate 110 and the cover lens 120, the viscosity of the sealing colloid 131 ranges for example 500 to 5000 mPa•s (25 □) to adhere to the touch sensor substrate 110 and the cover lens 120. The viscosity of the sealing colloid 131 can be measured with various types of viscometers, such as a rotational viscometer, a falling ball viscometer and a capillary viscometer.

The spacers 132 are for the sealing frame 130 to have a thickness in a predetermined value. Specifically, the spacers 132 are mixed into the sealing colloid 131 and in direct contact both with the peripheral region of the top surface 110S of the touch sensor substrate 110 and with the peripheral region of the bottom surface 120S of the cover lens 120 when the cover lens 120 is attached to the touch sensor substrate 110 by the sealing frame 130. In the instant embodiment, the spacers 132 are mixed into the sealing colloid 131 in a weight percentage ranging from 1% to 20%. The spacers 132 can all have the same height H1, and when the cover lens 120 is attached to the touch sensor substrate 110 by the sealing frame 130, the thickness of the sealing frame 130 is substantially equal to the height H1 of the spacers 132. Thereby, the sealing frame 130 can keep the top surface 110S of the touch sensor substrate 110 and the bottom surface 120S of the cover lens 120 in distance, such that a gap G is formed between the touch sensor substrate 110 and the cover lens 120. As shown in FIG. 1, FIG. 2B or FIG. 2C in the instant embodiment, the spacers 132 are rigid balls and have a height H1 measured 10 to 300 micrometers.

The spacers 132 can be made of at least one material selected from glass, plastic, and polymer. The hardness of the spacers 132 is measured for example 1 H to 3 H. The dimension, the shape, and the number of the spacers 132 may vary and one skilled in the art can employ different configuration. The spacers 132 mixed into the sealing frame 130 arranged between the touch sensor substrate 110 and the cover lens 120 are for keeping the top surface 110S of the touch sensor substrate 110 and the bottom surface 120S of the cover lens 120 in distance. Attention is now invited to FIG. 2C, when the touch panel assembly structure 1 of the instant disclosure is not in operation, which for example is that when the cover lens 120 is not in contact with or pressed by the user's finger, the distance between the top surface 110S of the touch sensor substrate 110 and the bottom surface 120S of the cover lens 120 is constant, which ranges from 10 to 300 micrometers. Thereby, the touch sensor substrate 110 and the cover lens 120 with respect to the sensing region A are not in direct contact.

It is worth to note that, a plurality of spacers 132 can be first mixed into a sealing colloid 131, and the sealing colloid 131 having the spacers 132 is then disposed on the top surface 110S of the touch sensor substrate 110 and surrounding the sensing region A. Then, the cover lens 120 is disposed onto the sealing colloid 131 having the spacers 132 mixed therein. Subsequently, the sealing colloid 131 having the spacers 132 mixed therein, which is disposed between the touch sensor substrate 110 and the cover lens 120, can be cured for forming the sealing frame 130. Thereby, the cover lens 120 is attached to the touch sensor substrate 110 by the sealing frame 130. Alternatively, the sealing colloid 131 can be first disposed on the top surface 110S of the touch sensor substrate 110 and surrounding the sensing region A and a plurality of spacers 132 are then mixed into the sealing colloid 131 disposed on the touch sensor substrate 110. The cover lens 120 is then disposed onto the sealing colloid 131 having the spacers 132 mixed therein. Subsequently, the sealing colloid 131 having the spacers 132 mixed therein, which is disposed between the touch sensor substrate 110 and the cover lens 120, can be cured for forming the sealing frame 130.

In addition, in one exemplary embodiment, a sealing colloid 131 can be first pre-cured, and a plurality of spacers 132 are then mixed in to the pre-cured sealing colloid 131. Subsequently, the pre-cured sealing colloid 131 having the spacers 132 mixed therein can be fully cured for forming the sealing frame 130, in which the final curing rate is for example greater than 95%.

In the instant disclosure, the sealing colloid 131 having the spacers 132 mixed therein is disposed on the touch sensor substrate 110 first, and the cover lens 120 is subsequently disposed onto the sealing colloid 131 for assembling. In an alternative embodiment, the sealing colloid 131 having the spacers 132 mixed therein can be disposed on the cover lens 120 first, for example, on the decoration ink in the periphery portion of the bottom surface 120S of the cover lens 120. The touch sensor substrate 110 is next disposed onto the sealing colloid 131 for assembling.

A plurality of transparent elastic elements 140 are disposed in the gap G and arranged within the sensing region A. In one exemplary embodiment, a liquid filler, a solid filler or a gaseous filler having low activity such as air, nitrogen, helium, and argon gas, can be filled into the gap G before the transparent elastic elements 140 are disposed in the gap G. The height H2 of the transparent elastic elements 140 can be less than or equal to the height H1 of the gap G, and the preferable height H2 of the transparent elastic elements 140 ranges from 5 to 300 micrometers. In the instant embodiment, the transparent elastic elements 140 are spherical and have the diameter measured 5 to 300 micrometers. The transparent elastic elements 140 may be disconnected from one another and uniformly distributed throughout the sensing region A in an area percentage ranges from 1% to 20%.

Printing, developing, coating or the like may be carried for the formation of the transparent elastic elements 140. For example, a layer of transparent elastic material having a discontinued pattern may coat on the surface 110S of the touch sensor substrate 110 in the sensing region A for forming the transparent elastic elements 140. The transparent elastic elements 140 can be made of thermosetting resin, ultraviolet curable resin or UV curable transparent ink.

The transparent elastic elements 140 can be made of visually transparent material transparent to the radiation at one or more wavelengths in the range of the spectrum such that the transparent elastic elements 140 can be transparent to the radiation at one or more wavelengths in the range of the spectrum. For example, the light transmittance of the transparent elastic elements 140 with respect to visible light ranges from 95% to 100%. Alternatively, the transparent elastic elements 140 can be transparent to the radiation at one or more wavelengths in the range of the infrared or ultraviolet spectrum.

In the instant embodiment, the transparent elastic elements 140 are formed on the touch sensor substrate 110's surface 110S that is facing the cover lens 120. In an alternative embodiment, the transparent elastic elements 140 can be formed on of the cover lens 120' surface 120S that is facing the touch sensor substrate 110. In addition, each of the transparent elastic elements 140 can be stacked on one another. In other words, the transparent elastic elements 140 disposed in the gap G may have a layered structure.

The transparent elastic elements 140 can be made of material containing at least one elastic material. Alternatively, the transparent elastic elements 140 can be made of material containing no elastic material, and each of the transparent elastic elements 140 can be configured to a structure such as foam like structure so as to have elasticity.

As shown in FIG. 2C in the instant embodiment, when the touch panel assembly structure 1 of the instant disclosure is not in operation, which for example is that when the cover lens 120 is not in contact with or pressed by the user's finger, the transparent elastic elements 140 disposed in the gap G are not in contact with the bottom surface 120S of the cover lens 120.

When the touch panel assembly structure 1 of the instant disclosure is in operation, which for example is that when the cover lens 120 is in contact with or pressed by the user's finger as shown in FIG. 1 in the instant embodiment, the cover lens 120 may deform such that at least one of the transparent elastic elements 140 is in contact with the bottom surface 120S of the cover lens 120. The transparent elastic elements 140 in contact with the bottom surface 120S of the cover lens 120 can hold up the deformed cover lens 120 against the pressing force down to the touch sensor substrate 110 and keep the cover lens 120 with respect to the sensing region A from being in direct contact with or stuck onto the touch sensor substrate 110. In addition, the portion of the cover lens 120 that is in contact with the transparent elastic elements 140 can be bounced up and separated from the transparent elastic elements 140 due to the elasticity of transparent elastic elements 140 when the cover lens 120 is no longer in contact with or pressed by the user's finger.

In the instant embodiment, the touch sensor substrate 110 further has a touch sensing layer 111 formed on the surface 110S thereof and disposed in the gap G. The touch sensing layer 111 can be a capacitive touch sensing layer. The touch sensing layer 111 can only cover a portion of the surface 110S of the touch sensor substrate 110 and can be disposed on an insulating layer on the surface 110S of the touch sensor substrate 110. The touch sensing layer 111 may include at least one sensing electrode and at least one wiring electrically connected to the sensing electrode. For example, the touch sensing layer 111 can include a plurality of transparent sensing electrodes connected in series respectively in X axis and in Y axis, forming an array, and the shape of each of the transparent sensing electrodes can be triangle, rhombus or bar type and the instant disclosure is not limited thereto. In the instant disclosure, the touch sensing layer 111 has single-layered structure disposed on the top surface 110S of the touch sensor substrate 110. In another exemplary embodiment, the touch sensing layer 111 may have double-layered structure disposed on the top surface 110S of the touch sensor substrate 110.

### Second Embodiment of Touch Panel Assembly Structure

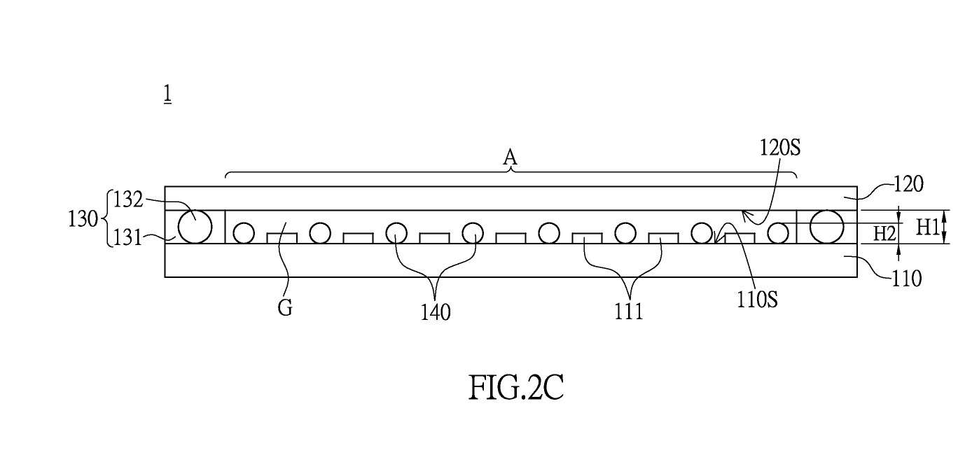

Please refer to FIG. 3, which illustrates a cross section view of a touch panel assembly structure in accordance with another embodiment of the instant disclosure. The touch panel assembly structure 2 in the instant embodiment is similar to the aforementioned touch panel assembly structure 1 and the description hereinafter further explains the difference there-between. As shown in FIG. 3, the transparent elastic elements 140 are hemisphere like and have a height H2 measured 5 to 300 micrometers. The transparent elastic elements 140 are similar to one another and disconnected from each other.

### Third Embodiment of Touch Panel Assembly Structure

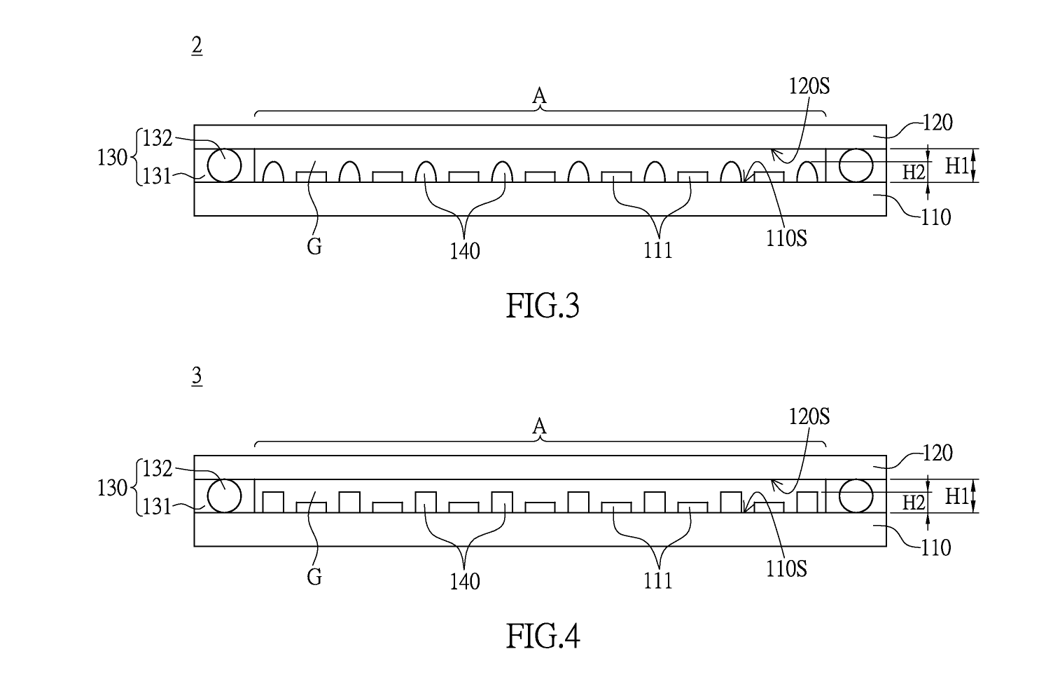

Please refer to FIG. 4, which illustrates a cross section view of a touch panel assembly structure in accordance with another embodiment of the instant disclosure. The touch panel assembly structure 3 in the instant embodiment is similar to the aforementioned touch panel assembly structure 1 and the description hereinafter further explains the difference there-between. As shown in FIG. 4, the cross-sectional shape of each of the transparent elastic elements 140 is rectangular. The transparent elastic elements 140 have a height H2 measured 5 to 300 micrometers. The transparent elastic elements 140 are similar to one another and disconnected from each other.

According to the embodiment, the touch panel assembly structures 1, 2, 3 utilize the spacers 132 mixed into the sealing colloid 131 to keep the sealing frame 130 to have a thickness in a predetermined value. Hence, when the touch panel assembly structure 1, 2, 3 of the instant disclosure is not in operation, the touch sensor substrate 110 and the cover lens 120 with respect to the sensing region A are not in direct contact. The touch panel assembly structures 1, 2, 3 utilize the transparent elastic elements 140 to hold up the deformed cover lens 120 against the pressing force down to the touch sensor substrate 110 and keep the cover lens 120 with respect to the sensing region A from being in direct contact with or stuck onto the touch sensor substrate 110. In addition, the portion of the cover lens 120 that is in contact with the transparent elastic elements 140 can be bounced up and separated from the transparent elastic elements 140 due to the elasticity of transparent elastic elements 140.

While the invention has been disclosed with respect to a limited number of embodiments, numerous modifications and variations will be appreciated by those skilled in the art. It is intended, therefore, that the following claims cover all such modifications and variations that may fall within the true spirit and scope of the invention.

What is claimed is:

1. A touch panel assembly structure, comprising:
a touch sensor substrate, the surface of the touch sensor substrate having a sensing region;
a cover lens facing the touch sensor substrate;
a sealing frame disposed on the surface of the touch sensor substrate and surrounding the sensing region, the sealing frame including
a sealing colloid; and
a plurality of spacers mixed into the sealing colloid,
wherein the cover lens is attached to the touch sensor substrate by the sealing frame such that a gap is formed between the touch sensor substrate and the cover lens; and
a plurality of transparent elastic elements disposed in the gap and arranged within the sensing region.

2. The touch panel assembly structure of claim 1, wherein the spacers are rigid balls.

3. The touch panel assembly structure of claim 1, wherein the height of the spacers ranges from 10 to 300 micrometers.

4. The touch panel assembly structure of claim 1, wherein the spacers are mixed into the sealing colloid in a weight percentage ranging from 1% to 20%.

5. The touch panel assembly structure of claim 1, wherein the height of the transparent elastic elements ranges from 5 to 300 micrometers.

6. The touch panel assembly structure of claim 1, wherein the light transmittance of the transparent elastic elements ranges from 95% to 100%.

7. The touch panel assembly structure of claim 1, wherein the transparent elastic elements are disconnected from each other.

8. The touch panel assembly structure of claim 1, wherein the transparent elastic elements are uniformly distributed throughout the sensing region in an area percentage ranging from 1% to 20%.

9. The touch panel assembly structure of claim 1, wherein the touch sensor substrate has a touch sensing layer formed on the surface of the touch sensor substrate and disposed in the gap.

10. The touch panel assembly structure of claim 9, wherein the touch sensing layer is a capacitive touch sensing layer.
